(19) United States
(12) Patent Application Publication
(10) Pub. No.: US 2007/0246542 A1
(43) Pub. Date: Oct. 25, 2007

(54) Document element repair

(75) Inventor: Gene Manheim, Sunnyvale, CA (US)

Correspondence Address: DAVID LEWIS, 1250 AVIATION AVE., SUITE 200B, SAN JOSE, CA, 95110, US

(73) Assignee: Inlite Research, Inc.

(21) Appl. No.: 11/786,505

(22) Filed: Apr. 11, 2007

Related U.S. Application Data
(60) Provisional application No. 60/790,911, filed on Apr. 11, 2006.

(51) Int. Cl. G06K 19/00

(52) U.S. Cl. 235/487

(57) ABSTRACT

A barcode or other additional document element is detected. An improved version of the barcode or other additional document element is generated. The improved version may be a different geometry (e.g., a larger size) so that the barcode or other additional document element is easier to read (e.g., with a barcode reader or other device designed for reading other additional document elements).

### CROSS-REFERENCE TO RELATED APPLICATIONS

This application claims priority to U.S. Provisional Application Ser. No. 60/790,911, entitled “Document Element Repair,” filed Apr. 11, 2006 by Gene Manheim (Docket # 27-3), which is incorporated herein by reference. This application also incorporates herein by reference U.S. patent application Ser. No. 11/360,929 (Docket # 27-1), filed Feb. 22, 2006, entitled, “Determining Information About Documents,” U.S. Provisional Application No. 60/757,664 (Docket # 27-2), entitled, “Automatic Placement of an Object on a Page,” filed Jan. 25, 2006, U.S. application Ser. No. 11/637,270, filed Dec. 11, 2006 (Docket # 27-4), also entitled, “Automatic Placement of an Object on a Page,” and PCT Application PCT/US07/00387, filed Jan. 5, 2007 (Docket # 27-5) also entitled, “Automatic Placement of an Object on a Page,” all of which are by Gene Manheim.

### FIELD

This specification relates to the repair of an object on a page.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Barcodes may be placed on a number of different types of documents (e.g., product labels) for a variety of purposes. However, the barcodes may become unreadable after copying and/or with time. Codes, such as barcodes, may be used to reliably encode and then retrieve information on documents. If, for example, the barcode is located on a hard copy of a document the data contents associated with the code may be obtained using a reading device. For example, the reading device may be a scanner, and the reading may be performed by passing the document through an image scanner and over a printed document page, and by using code recognition software to find and decode the code on an image of the document. If, for example, the barcode is located within a softcopy, such as a PDF file, a computer program may detect and/or decode the barcode. Other document elements may be located and recognized in a similar way.

Some document elements (e.g., barcodes) may have certain standards that the document element is supposed to adhere to. The quality of the document element is affected by how well the generator of the document element adheres to the standards, the parameters of the document element (type and geometry), distortions imparted by the printing processes and introduced by the scanning process.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1A shows a block diagram of an embodiment of a barcode repair system.

FIG. 1B shows a block diagram of an embodiment of instructions of FIG. 1A.

FIG. 2 shows a block diagram of an embodiment of a barcode having a quiet zone.

FIG. 3A shows an example of a barcode having a different symbology than parallel lines.

FIG. 3B shows an example of a barcode having a different geometry and symbology than the barcode of FIG. 3A.

FIG. 4A shows an embodiment of a method of repairing document elements.

FIG. 4B shows a table of examples of damaged and repaired barcodes.

FIG. 4C shows an enlargement of the damaged barcodes.

FIG. 5 shows a flowchart of an embodiment of a method of making a system for automatically repairing a barcode on a document.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In this specification, the term repair is to be understood as generic to a partial repair and a full repair. A method may be used to repair the impaired document element in the document or in the document image so as to improve, partially restore, fully restore, or preserve salient characteristics of the document element or of the quality of the document element. In an embodiment, the repair of document elements in the original documents is performed separately from the document application software after it has created the document. In an embodiment, the repair of document elements may be performed after the document elements have been acquired by an image scanner, fax or other image acquisition device.

In this specification, an image is a visual reproduction of an object. In this specification, the word “code” may refer to any string or pattern of characters and/or shapes that convey information other than an aesthetic appearance. In other words, a pattern that contains no other information other than its aesthetic appearance is not a code, but a pattern or string of characters that carries information (whether or not the pattern has other aesthetic features) is a code. For example, a pattern of dots, bars or characters is a code, but a picture is not a code unless other information is encoded therein in addition to the image conveyed. One example of a code is a barcode. In this specification, a barcode (which may also be referred to as a bar code) is a machine-readable representation of information in a visual format on a surface or in an image of a surface. Although this specification discusses barcodes, barcodes are discussed only as an example. Anywhere in the specification, any document element may be substituted for the barcodes to get other embodiments.

In some locations the specification discusses repairing an additional document element instead of a barcode or for a barcode instead of an additional document element. The terms “replacement element” or “replacement document element” refer to document elements that replace and/or supplement other document elements that were already present. In this specification, the terms “additional document element” or “additional element” refer to document elements, such as barcodes, that are added to the document element, regardless of whether document element added is replacing another document element. The term additional document element or additional element may also be any other type of element that is added to the document. In this specification, the word barcode may be substituted for the term additional document and the term additional document element may be substituted for the word barcode wherever either of these the terms appear in the specification in order to obtain other embodiments. In this specification, as a shorthand for the term “additional document element” the term “additional element” or “document element” may be used.

The image of the barcode may be the result of scanning, photocopying, faxing, and/or other processes that produce an image. If the quality of the barcode as presented to the input of the reading device falls below a certain threshold required by that reading device, then some of the contents of the barcode may not be read or recovered from the document. Often the user has little to no control over the quality of the barcode in the original document or the document image. This lack of control on the quality of the original image constrains subsequent imaging operations with the document or the document image, which may result in the user not being able to read the barcode. For example, the user might not be able to fax or scan printed versions of the document image, because of the low quality of the document image.

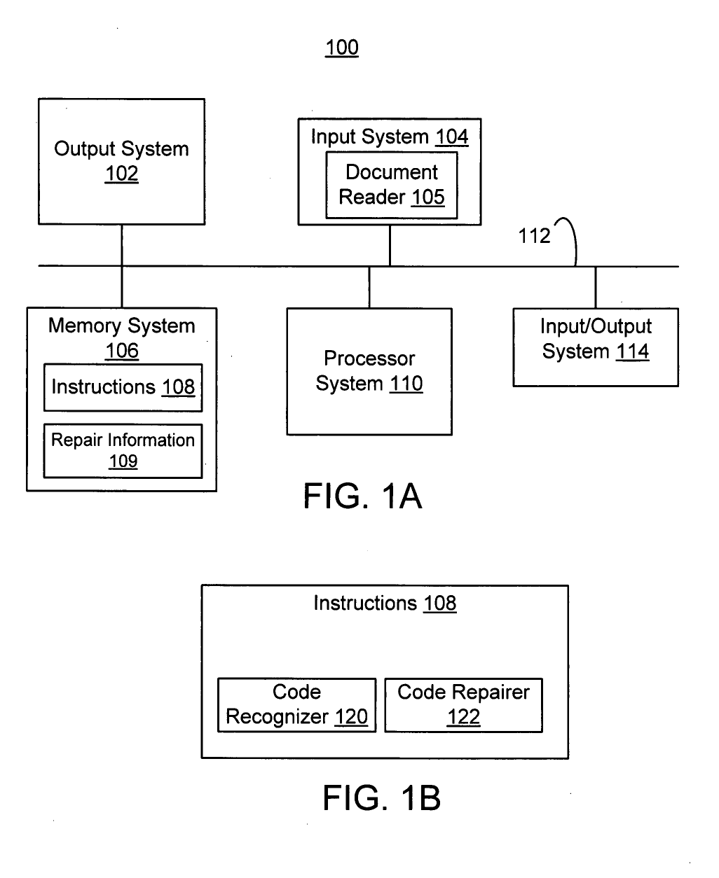

FIG. 1 shows a block diagram of barcode repair system 100 that may include output system 102, input system 104, document reader 105, memory system 106, instructions 108, repair information 109, processor system 110, communications system 112, and input/output system 114. In other embodiments, barcode repair system 100 may not have all of the components listed above and/or may have other components in addition to, or instead of, those listed above.

Barcode repair system 100 is an example of a system that may be used for automatically locating and placing barcodes on documents. Barcode repair system 100 may be an individual machine or may be a system including many different machines. For example, barcode repair system 100 may be one or more computers running a barcode repair program connected to a variety of peripheral devices.

Output system 102 may include any one of, some of, any combination of, or all of one or more handheld display devices, one or more printers, a speaker system, one or more interfaces to a sound system, one or more interfaces to peripheral devices and/or one or more interfaces to a computer system, intranet, and/or internet, for example. Additionally, output system 102 does not necessarily have any of the various output systems listed above, but may have another output system instead. Output system 102 may be used for outputting documents and/or document images that include an embedded, repaired barcode. A software and/or hardware module (e.g., including barcode repair software) may be located inside output system 102 (for example, inside a printer and/or or printer driver—or e.g., as an internal function) for repairing the barcodes on documents. The barcodes may be repaired and added just before printing, via a printer. Having a barcode repair module associated with the printer driver may facilitate keeping the barcode repair process universal (e.g., equally available) to all applications capable of printing documents and may facilitate keeping the quality of the barcodes above predetermined quality threshold.

Input system 104 may include any one of, some of, any combination of, or all of, one or more mice, one or more track balls, one or more track pads, buttons on one or more handheld devices, one or more scanners, one or more microphones, one or more interfaces to a sound system, and/or one or more interfaces to a computer system, intranet, and/or internet (e.g., IrDA, USB), for example. Additionally, input system 104 does not necessarily have the various input systems listed above, but may have another input system instead. Input system 104 may be used for scanning documents or receiving electronic versions of documents. Input system 104 may also be used for receiving a document or document image having a barcode that may need to be repaired. Input system 104 may include document reader 105, which may include a scanner, a digital imager, and/or a check transport, for example. A software and/or hardware module (e.g., including barcode repair software) may be located inside input system 104 (for example, inside reader 105, such as a scanner, and/or inside a scanner driver—e.g., as an internal function) for repairing the barcodes on documents. The barcode may be repaired immediately after acquiring the image, via scanning or receiving the image at a document reader 105 (e.g., at a scanner or other document reader). Having a barcode repair module associated with the scanner driver or other document reader may facilitate keeping the barcode repair process universal (e.g., equally available) to all applications capable of scanning and/or reading documents and may also facilitate keeping the quality of the barcodes above a certain predetermined threshold. The barcode repair software in input system 104 may be in addition to or instead of the barcode repair software in output system 102.

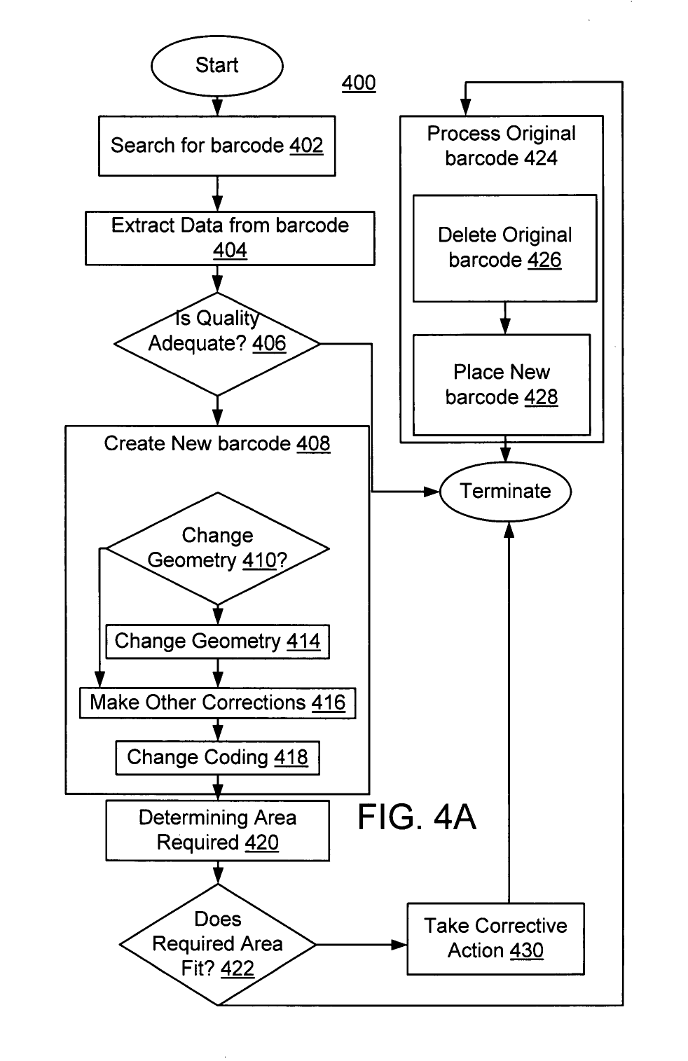

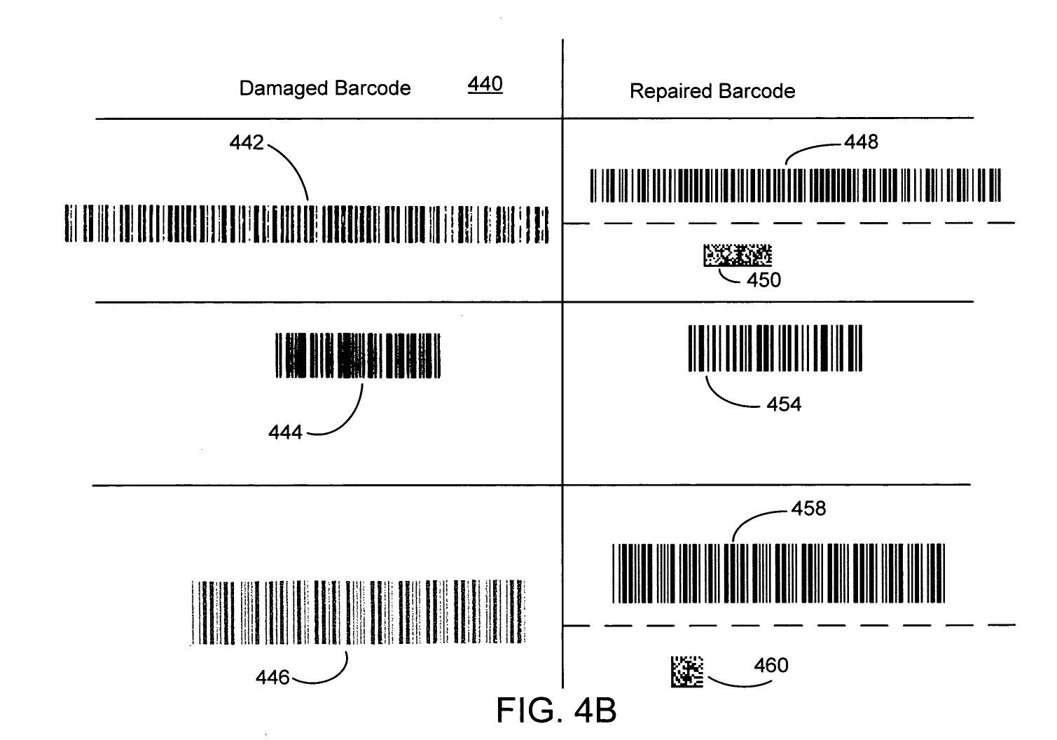

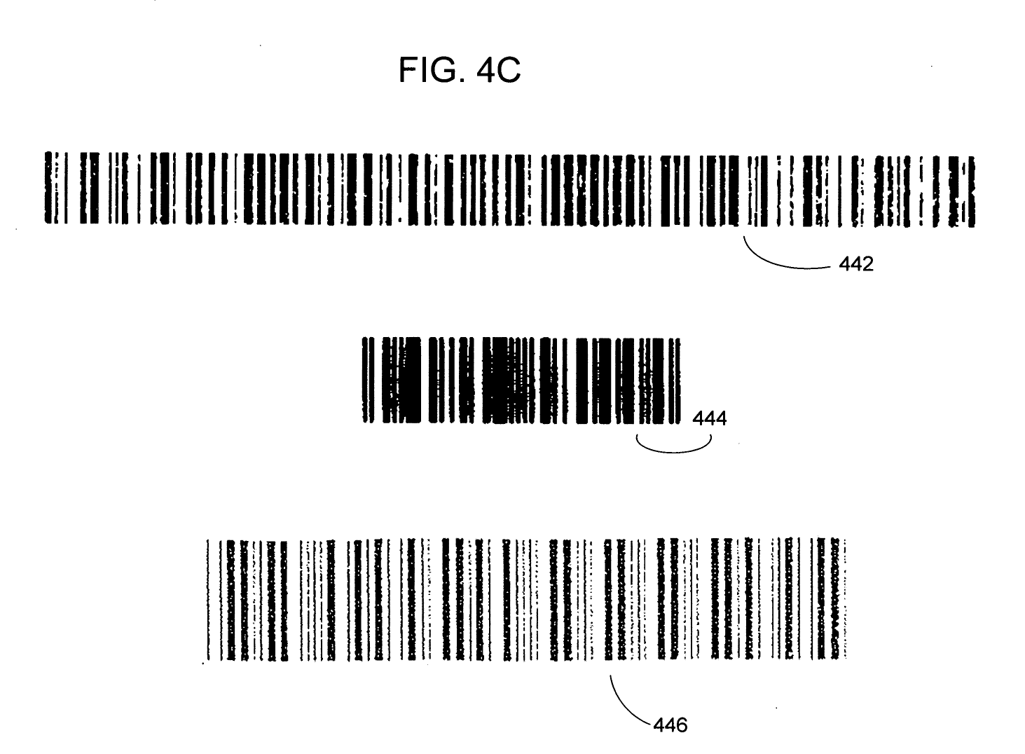

Memory system 106 may include, for example, any one of, some of, any combination of, or all of a long term storage system, such as a hard drive; a short term storage system, such as random access memory; a removable storage system, such as a floppy drive or a removable drive; and/or flash memory. Memory system 106 may include one or more machine-readable media that may store a variety of different types of information. The term machine-readable medium is used to refer to any medium capable of carrying information that is readable by a machine. One example of a machine-readable medium is a computer-readable medium. The term machine-readable medium also includes mediums that carry information while the information is in transit from one location to another, such as copper wire and/or optical fiber. Memory system 106 may store one or more instructions for repairing barcodes (e.g., barcode repair software). Memory system 106 may include one or more instructions for carrying out any one of, any portion of, any combination of, or all of the methods of FIG. 4A.

Instructions 108 may include barcode repair software, which may include one or more instructions for automatically repairing a barcode. Repairing the barcode may involve any of several combinations of several different operations, which may include finding the barcode in a document, adjusting the size of the barcode, reading the information in the barcode, removing noise from the barcode, generating a new barcode as a replacement or supplement to the original barcode, finding a location for the new barcode, and/or removing the old barcode. In an embodiment, instructions 108 may also analyze the quality of a barcode to determine whether the barcode needs to be repaired. Instructions 108 may be the one or more instructions stored in memory system 106 that cause a processor to carry out the any combination of the methods of FIG. 4, which are discussed below. In this specification the terms methods and processes may be substituted for one another anywhere either appears to get new embodiments. Different parts of instructions 108 may be stored on and/or performed by different machines of barcode repair system 100.

Repair information 109 is optional, and includes information about the barcodes that were repaired. Repair information 109 may include information such as when barcode was repaired, why the barcode was repaired, the nature of the repair performed, and information identifying the document and/or company for which the barcode was repaired. Repair information may include an index for locating the repair information. Repair information may be included in a database. Optionally the repair information may be located on a different machine than the machine that performs the repairs.

Processor system 110 may include any one of, some of, any combination of, or all of multiple parallel processors, a single processor, a system of processors having one or more central processors and/or one or more specialized processors dedicated to specific tasks. Processor system 110 may carry out instructions 108 and/or other instructions stored in memory system 106.

Communications system 112 communicatively links output system 102, input system 104, memory system 106, processor system 110, and/or input/output system 114 to each other. Communications system 112 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

FIG. 1B shows a block diagram of an embodiment of instructions 108, which may include code recognizer 120 and code repairer 122. In other embodiments, instructions 108 may not have all of the components listed above and/or may have other components in addition to, or instead of, those listed above. Code recognizer 120 may search a document for a barcode and identify a barcode. Code repairer 122 may generate a repaired version of the barcode and insert the barcode into a document.

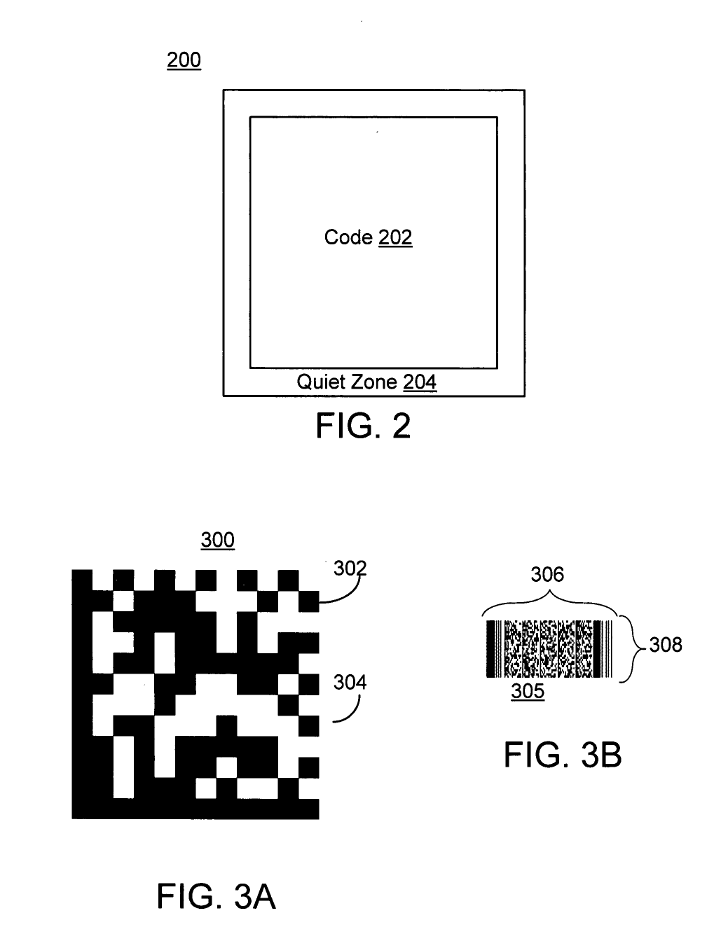

FIG. 2 shows a block diagram of a barcode 200, which may include code 202 and quiet zone 202. In other embodiments, barcode 200 may not have all of the elements listed above and/or may have other elements in addition to, or instead of, those listed above.

Code 202 represents the actual code that makes up barcode 200. One type of barcode (that code 202 may represent) stores data in parallel lines, which may be referred to as bars, that have different widths and/or that are spaced from one another by different amounts. The information in the barcode may be stored in the distances between the beginnings of two adjacent bars and/or the distances between the ends of two adjacent bars. Alternatively, the information may be stored in the widths of bars and/or the spaces between bars. However, there are many types of barcodes that may be represented by code 202.

In one embodiment, code 202 is a two-dimensional barcode. In an embodiment, code 202 may be a matrix of code (which is a type of two-dimensional barcode) that does not consist of bars but rather a grid of square cells or cells of another geometry (e.g., another shape), such as a grid of rectangles, triangles, and/or hexagons. Each cell may contain one or more geometric shapes. Thus, depending on the embodiment, code 202 may be one or more patterns of dots, rectangles, concentric circles, and/or other geometric shapes, which may be hidden in images. In an embodiment, code 202 may be formed by taking barcodes formed by parallel bars and placing them in multiple rows, where the rows are encoded in the same manner as a single row barcode or with a different coding. A barcode formed from rows of parallel bars placed one on top of another may be referred to as a stacked barcode.

In one embodiment, code 202 may include encoding schemes that represent just numbers. In another embodiment, code 202 may represent other types of characters, such as characters from the upper case alphabet, the complete ASCII character set, and/or other symbols. Although in the above embodiments, code 202 forms a barcode, code 202 may be another type of code or object.

Quiet zone 204 may be a region of blank space or possibly low noise surrounding code 204, which may be associated with barcode 200. Quiet zone 204 may facilitate distinguishing code 202 from other document elements. In an embodiment, quiet zone 204 is one or two times the width of the narrowest element of the barcode. In this specification, the terms barcode, code, document element, and additional document element include the quiet zone if a quiet zone is present. In other words, the terms barcode and code are generic to a barcode or code that has a quiet zone and to a barcode or code that does not have a quiet zone, but if a quiet zone is present the quiet zone will be considered as part of the barcode or code. The quiet zone is not necessarily white space, but could be color spaces or other types of low noise (or low interference) regions. Quiet zone size violation maybe one of damages to the original barcode that requires repair.

FIG. 3A shows an example of a barcode 300 of a different symbology than parallel lines. Barcode 300 may include code 302 and quiet zone 304. In other embodiments, barcode 300 may not have all of the elements listed above and/or may have other elements in addition to, or instead of, those listed above. Barcode 300 is a matrix type barcode. In an embodiment, when repairing a barcode the barcode may be replaced with a barcode having a different symbology than the original barcode. Symbologies are systems of encoding data such that a scanner and/or a decoding system may together read and decode the data encoded in the barcode. Aside from the actual technique of encoding the barcode pattern, a number of technical specifications or characteristics define and separate one symbology from another. In an embodiment, quiet zone 304 does not have any lines or markers marking its border.

FIG. 3B shows another example of a barcode 305 having barcode width 306 and barcode height 308. In other embodiments, barcode 305 may not have all of the features depicted and/or may have other features in addition to, or instead of, those depicted above.

Barcode 305 has a different geometry and symbology than barcode 300. In contrast to the barcode of FIG. 3A, which is a square, barcode width 306 is different than barcode height 308. The same information may be stored in different barcodes having different geometries, having different barcode widths and heights, which may not be rectangular, and/or which may be rotated. The barcode geometry may be altered to fit a location that is available for placing a barcode. When a barcode is replaced with a repaired barcode, the repaired barcode may have a different geometry (e.g., in order to fit the new barcode into the new location, to make the barcode easier to read, and/or for other reasons). Optionally, the original barcode may be enlarged prior to reading the barcode, so that the barcode is easier to read. Optionally, a check may be performed to see if the original barcode is below a certain size, and then if the original barcode is below a certain size the barcode may be enlarged prior to reading the barcode. In an embodiment, after reading the barcode a new barcode is generated with the same information. In this embodiment, since the repaired barcode is a newly generated barcode, the defects introduced as a result of the document aging, as a result of poor quality equipment, or as a result of other factors are not present in the repaired barcode.

FIG. 4 shows an embodiment of a method 400 of repairing documents. Method 400 implants a correctly formed and repaired barcode in place of the existing lower quality barcode.

In step 402, a search may be performed for the original barcode in the document image or in the document file. Step 402 may involve, after the original barcode is found, the location of the barcode may be identified. In step 404, the barcode's data contents may be extracted. The extraction may perform any of several techniques to filter out noise and/or correct other errors that may result in an inaccurate reading of the barcode. Optionally, in step 406, the quality of the barcode that was found may be analyzed, and a determination of whether the quality of the barcode is good or is at least adequate (e.g., whether the quality of the detected element would be above a specified threshold). If the quality of the barcode is adequate, then method 400 proceeds to step 408, where the repair process is terminated.

Returning to step 406, if the quality of the barcode is not adequate, method 400 proceeds to step 408. Alternatively, in an embodiment in which step 406 is not performed, method 400 proceeds from step 404 directly to step 410 without checking the quality of the barcode. In step 408, a barcode having the same data content and that is of the same type as the original barcode may be created. In an embodiment, step 408 may includes a plurality of sub-steps. In step 410, which is a sub-step of step 408, a check is made as to whether changing the geometry of the barcode will improve the quality of the barcode.

If changing the geometry of the document is expected to improve the barcode, then method 400 proceeds to step 414 where the geometry of the barcode is changed. As an example of some of the operations that may be performed in step 414, the geometry may be altered to increase the module size. As another example, the geometry of the document may be altered to compensate for an expected distortion, such as an expected distortion resulting from the location of the barcode on the document (e.g., edge distortions resulting from the barcode being located at the edge of the document). Barcodes generated based on font technology often fail to scale properly and the resulting scaled symbols may not meet standard specifications for these barcodes. In an embodiment, in step 414, the geometry of the barcode is distorted to compensate for an expected distortion resulting from basing the barcode on the font technology. After step 414 method 400 proceed to step 416, which will be discussed below.

Returning to step 410, if the step 410 determines that changing the geometry is not expected to improve the quality of the barcode, method 400 proceeds from step 410 to step 416. Alternatively in an embodiment that does not include steps 410 and 414, method 400 proceeds from step 410 directly to step 416.

In step 416, other corrections are made to the barcodes. Specifically, the document may be subject to a variety of impairments. For example, some documents may be printed on low quality printers (such as dot matrix printers), or printed on the back pages of a multipart document. Documents scanned at too low a resolution or at incorrect scanner settings may suffer from white speckle noise on parts of the barcodes. Similarly, the photocopied version of the barcode may have black whiskers that may corrupt the edge geometry of the barcodes. Accordingly, in an embodiment, as part of step 416, whiskers, and/or speckles are removed. For example, speckles and whiskers may be removed by removing spaces, lines, and/or other parts having feature sizes significantly smaller than the smallest expected feature size for the document in question.

In step 418, a new code may be created as a replacement or as a supplement to the original code (e.g., using the geometry of step 414). The new code may be of a different type. For example, optionally, as another step, it may be desirable to change the barcode type or type of encoding (e.g., the type of symbology), in order to create a more robust barcode. In one embodiment, one barcode may be replaced with multiple barcodes. It may be desirable to change the symbology of the barcode. For example, it may be desirable to use symbology that utilizes error detection or error correction, or that encodes the data in a more compact space.

In step 420 the area required for the replacement barcode (including a “quiet zone”) may be determined. In step 420, if the barcode has a quiet zone, determining the area required by the replacement barcode, may include determining the area required by the barcode including the area occupied by the quiet zone. In an embodiment, even if the original barcode does not have a quite zone a quite zone is added to the new barcode to improve the readability of the barcode.

In step 422, a check may be performed to see if the replacement area fits into the preexisting barcode area, and does not interfere with nearby image elements. If the original barcode area is sufficiently large and appropriately shaped, then method 400 may proceed to optional step 424. In step 424, several steps for processing the original barcode may be performed. For example, in step 426, which in an embodiment is a sub-step of step 424, the image of the original barcode may be deleted. In step 428, which in an embodiment is another sub-step or step 424, the image of the replacement barcode may be placed within the original barcode area.

Returning to step 422, if it is determined that the original barcode area is insufficient, then method 400 may proceed to step 430. In step 430 one or more of several corrective actions may be taken. Step 430 may include generating a replacement barcode having a different type that fits into the original area and inserting the replacement barcode into the original area, which in turn may involve one or more of the following steps. A barcode may be created, where the barcode has the same data content, but has a different barcode type and/or geometry fitting in the available area.

As another alternative, if the replacement barcode does not fit, in step 430, a search may be performed for a location where the replacement document fits. As part of step 430, the replacement barcode may be located in a different area of the page or on a different page of a multipage document (see docket # 27-2 for a method for locating a position for a barcode). In another embodiment, if the barcode does not fit in the location of the original barcode, first a determination is made changing the geometry and/or symbology will result in the new barcode being able to fit in the original location. Then, if the new barcode still does not fit into the original location a new search is performed for a new location. In another embodiment, if the barcode does not fit in the location of the original barcode, first a new search is performed for a new location. Then, if no location is found, a determination is made whether changing the geometry and/or symbology will result in the new barcode being able to fit in the original location. Alternatively, even if the replacement barcode fits in the original location, there may be other reasons for placing the replacement barcode in a different location. After a new location is found for the replacement barcode, the old barcode area may be processed in one of the following ways. In one embodiment, step 430 may involve, deleting the image of the original barcode and leaving the area of the original barcode blank. Alternatively, a second copy of the new barcode may be placed in the place of the original barcode. Another alternative is to leave the original barcode in place. In this alternative there would be two copies of the barcode in two locations. The new copy of the barcode would be located in a new location, and the original barcode would be located in the original location of the barcode. As another alternative, the new copy of the barcode would be located in the original location of the barcode and the original barcode would be located in the new location of the barcode. As yet another alternative, the image of the original barcode may be replaced with a smaller barcode, which may not have the same information. For example, the information contained in the new and possibly smaller barcode may include index information or another indication of the presence and the location of the replacement barcode.

In an embodiment, each of the steps of method 400 is a distinct step. In another embodiment, although depicted as distinct steps in FIG. 4A, step 402-430 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

FIG. 4B shows a table 440 of examples of damaged and repaired barcodes. Table 440 damaged barcodes 442, 444, and 446 and repaired barcodes 448, 450, 454, 458, and 460. There are many other types of damaged barcodes and types of repairs of barcodes. The barcodes of FIG. 4B are enlarged so that the details of the barcodes are easier to see. FIG. 4C shows a further enlargement of damaged barcodes 442, 444, and 446.

Damaged barcode 442 corresponds to repaired barcodes 448 and 450, damaged barcode 444 correspond to repaired barcode 454, and damaged barcode 446 correspond to damaged barcodes 458 and 460. Each of damaged barcode 442, 444, and 446 are examples of different types of defects. Damaged barcode 442 has bars that are broken. Damaged barcode 458 has bars that have merged together. Damaged barcode 444 (similar to damaged barcode 454) has broken bars. However, in contrast to damaged bar codes 444, damaged barcode 446 has bars with white holes within the bars.

Repaired barcodes 448 and 458 have the same symbology (and coding) as damaged barcodes 442 and 446 and contain essentially the same information or the same information as damaged barcode 442 and 446, respectively. Repaired barcodes 450, 454, and 460 also have the same information as damaged barcodes 442, 444, and 446, respectively, but have a different symbology and shape. Although damaged barcode 444 and repaired barcode 454 are both made up of bars, repaired barcode 454 has a different coding than damaged barcode 444. Repaired barcodes 450 and 460 are matrix type barcodes. As a result of the matrix type symbology, repaired barcodes 450 and 460 are more compact than their corresponding damaged barcodes 442 and 446. Additionally, repaired barcodes 450 and 460 include error correction information. Specifically, repaired barcodes 450 and 460 include redundant portions so that if some of the barcode is illegible the information in that part of the barcode may be found in another part of the barcode instead, thereby increasing the likelihood that even if part of the barcode is damaged all of the information the barcode contains is still recoverable.

In an embodiment, the data contents of the original barcode may be modified in the replacement barcode (e.g., by adding new data and/or updating old data). The reason for modifying the contents and the value of the barcode is defined by parameters of barcode repair operation. For example, in an embodiment, a timestamp and/or system identification (ID) are added (e.g., appended) to the barcode. The timestamp may record the date that the barcode was last repaired. The system ID may identify the system and/or the location at which the repair took place. Additionally, the barcode may include a portion that either is a code that includes a reason for a repair or is a code that indicates a database where the reason for the repair may be stored. The database that stores the reason for the repair may be the same as or different from the database that stores other information about the document.

The repair may be implemented as an internal function of a printer or printer driver. By incorporating the internal function, the repair process may be triggered by any applications capable of printing the document. For documents with a standardized file format structure (such as PDF) or a control API (such as Office Automation), the barcodes can be replaced into the document file. Barcodes can be replaced while using a standalone application or while using a plug-in or add-on module that is attached at runtime to the underlying application program. The barcode may be further edited by the user of the document application program.

Using the above methods, a barcode in an image of a document, such as a TIFF, BMP, JPEG, or PDF document, as well as a barcode in an original document file may be repaired. The repair may be implemented in a scanner or in a scanner driver immediately after the image of the document is acquired. The repair may be implemented via image processing software operating on document images. In an embodiment, the images processed may have a standard or custom format, such as TIFF, BMP, JPEG, or PDF. In an alternative embodiment, the new barcode is the original barcode enlarged without making any further improvements to the original barcode.

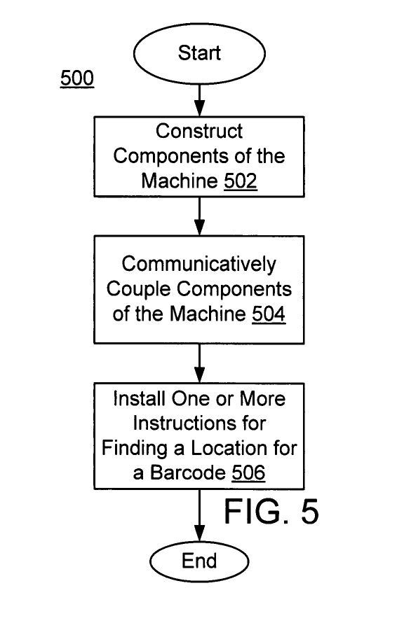

FIG. 5 shows a flowchart of an embodiment of a method 500 of making a system for automatically repairing a barcode on a document. In step 502, the components of barcode repair system 100 are constructed, which may include constructing output system 102, input system 104, memory system 106, processor system 110, and communications system 112.

In step 504, the components of barcode repair system 100 are communicatively coupled together, which may include communicatively coupling output system 102, input system 104, memory system 106, processor system 110, and communications system 112.

In step 506, instructions 108 are installed in memory system 106, which may include loading one or more instructions into memory system 106 that carry out method 400. In an embodiment, each of the steps of method 500 is a distinct step. In another embodiment, although depicted as distinct steps in FIG. 5, step 502-506 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

Any of the elements of the embodiments of this specification including any element of U.S. patent application Ser. No. 11/637,270 (27-4), U.S. Provisional Application Ser. No. 60/790,911 (Docket # 27-3), U.S. Provisional Application No. 60/757,664 (Docket # 27-2), and/or U.S. patent application Ser. No. 11/360,929 (Docket # 27-1) may be mixed and used together with any of the other elements of other embodiments of this specification and/or each other.

Each embodiment disclosed herein may be used or otherwise combined with any of the other embodiments disclosed. Any element of any embodiment may be used in any embodiment. Additionally any of the elements of the embodiments of this specification (including any element of docket # 27-1 or docket # 27-2) may be mixed and used together with any of the other elements of other embodiments of this specification (such as the elements of docket # 27-1 and/or docket # 27-2).

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
reading a code from a document, the code being part of an original document element; and
placing a new document element on the document, the new document element having the code in a form that is easier to read than the code in the original document element.

2. The method of claim 1, further comprising creating the new document element with a different geometry than the original document element.

3. The method of claim 1, further comprising deleting the original document element.

4. The method of claim 1, further comprising determining whether the original document element is of a quality that is above a predefined threshold.

5. The method of claim 1, further comprising creating the new document element of a larger size that the original document element.

6. The method of claim 1, the reading includes at least scanning the document with via a scanning process, which initiates the placing of the new document element.

7. The method of claim 1, the new document element being a first new document element, the method further comprising creating at least a second new document element, the first new document element and the second new document element each containing different information extracted from the original document element.

8. The method of claim 1, producing a revised version of the document including both the original document element and the new document element.

9. The method of claim 1, further comprising searching the document and finding a location of the original document element.

10. The method of claim 1, further searching the document for a location of the new document element and placing the new document element in the location found.

11. A method comprising:
scanning the document;
searching for a location where the original document element is located;
finding the location;
reading code in the original document element found at the location;
extracting data content from the original document element;
determining whether changing a geometry of the new document element is expected to improve the new document element;
if changing the geometry of the document element is expected to improve the new document element, the geometry of the new document element is changed; and
placing the new document element on a representation of the document.

12. The method of claim 11, further comprising:
analyzing the original document element to determine a quality associated with the original document element;
if the quality of the original document element is above a predetermined threshold, terminating the method;
if the quality of the original document element is below a predetermined threshold, a new document element is generated having data content extracted from the original document element;

13. The method of claim 11, the reading is associated with a scanning process, and the placing of the new document element is performed as a result of the scanning process.

14. A system comprising a machine readable medium storing one or more instructions, which when implemented cause a processor to carry out the method of claim 1.

15. A system comprising one or more machine-readable media storing one or more instructions for carrying out the method of claim 2.

16. A system comprising one or more machine-readable media storing one or more instructions for carrying out the method of claim 3.

17. A system comprising one or more machine-readable media storing one or more instructions for carrying out the method of claim 4.

18. A system comprising one or more machine-readable media storing one or more instructions for carrying out the method of claim 5.

19. A system comprising one or more machine-readable media storing one or more instructions for carrying out the method of claim 6.

20. A system comprising one or more machine-readable media storing one or more instructions for carrying out the method of claim 7.

21. A system comprising one or more machine-readable media storing one or more instructions for carrying out the method of claim 8.

22. A system comprising one or more machine-readable media storing one or more instructions for carrying out the method of claim 9.

23. A system comprising one or more machine-readable media storing one or more instructions for carrying out the method of claim 10.

24. A system comprising one or more machine-readable media storing one or more instructions for carrying out the method of claim 11.

25. A system comprising one or more machine-readable media storing one or more instructions for carrying out the method of claim 12.

26. A system comprising one or more machine-readable media storing one or more instructions for carrying out the method of claim 13.

27. A system comprising:
one or more machine-readable media storing one or more instructions for carrying out the method of claim 1;
a processor system for carrying out the one or more instructions;
an input system for receiving the document; and
an output system for producing the document with the additional document element.

28. A system comprising:
a first document having a code thereon; and
a second document that is identical to the first document except the second document has a repaired version of the code thereon.
